(19) United States
(12) Patent Application Publication
(10) Pub. No.: US 2024/0139073 A1
(43) Pub. Date: May 2, 2024

(54) Baby Bottle With Storage

(71) Applicant: Orlando Flores, Valdosta, GA (US)

(72) Inventor: Orlando Flores, Valdosta, GA (US)

(21) Appl. No.: 17/978,548

(22) Filed: Nov. 1, 2022

(51) Int. Cl. A61J 11/00; A61J 9/00

(52) U.S. Cl. CPC A61J 11/0095; A61J 9/005

(57) ABSTRACT

The Baby Bottle With Compartment is the only product of its kind that is carefully crafted with a compartment that can hold up to nine grams of baby formula, as a proactive means to ensure quick prep and accurate measurement. This unprecedented product is uniquely designed with durable, high-grade materials to ensure long-term sustainability and employs a smaller diameter, in comparison to other bottles which makes it easier to hold and leaves ample space for placing in storage bags.

### BACKGROUND

When it comes to care-taking, often the middle of the night feedings are the hardest parts of parenting an infant. As babies wake up to eat at random times for several months, parents must drag themselves out of bed in order to prepare a baby bottle; yet, the measuring, prepping and overall routine can be cumbersome. There have been no products available as original equipment or as an aftermarket to address this problem.

An apparatus to simplify the process for night feeding infants is not being met by any known device or system at present. There have been no products available as original equipment or as an aftermarket to address this problem either.

### SUMMARY OF THE INVENTION

The main purpose of the baby bottle with storage is to provide users with a baby bottle possessing a small formula compartment that enables users to easily prepare and measure out formula/powder in prep of a feeding.

A baby bottle device comprising a baby bottle having an end, a cylindrical side having at least one squeeze portion and a threaded top. The disclosure also includes a nipple ring having a nipple and a threaded ring configured to engage with the baby bottle threaded top and having a concentric lip adjacent the threaded ring. The disclosure additionally includes a dry storage having an open end received adjacent the concentric lip and a membrane for separation with a volume of the baby bottle, wherein the membrane is configured to rupture from a pressure on the at least one squeeze portion of the baby bottle and allow a mixing of the dry storage with a liquid in the volume thereof.

### BRIEF DESCRIPTION OF THE DRAWINGS

FIG. 1 is a front elevational view of the baby bottle with storage in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

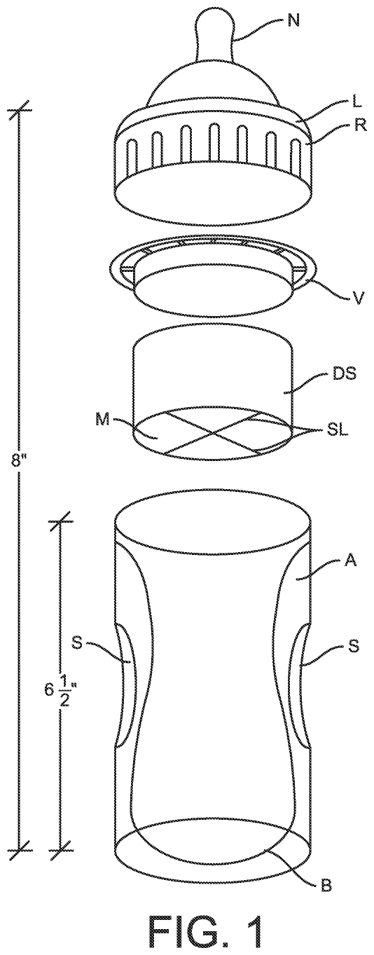

FIG. 1 is a front elevational view of the baby bottle with storage showing: baby bottle referenced as A, formula compartment with twist open bottom referenced as DS, vent referenced as V, a concentric lip referenced as L, a bottle's nipple referenced as N, a nipple ring referenced as R, a membrane referenced as M, scored lines or scored sections referenced as SL, and squeezable sections or portions referenced as S and bag B suspended from the threaded end of the baby bottle in accordance with an embodiment of the present disclosure.

The present disclosed baby bottle with storage, also known as “Baby Bottle With Compartment”, offers a modern accessory that makes those inevitable formula feeds as easy as possible by cutting preparation time in half; thus, saving time whether an individual is on the go or waking up in the middle of the night. Expanding on the initial design of an average baby bottle, the Baby Bottle With Compartment introduces a novel formula compartment with a twist open bottom. Users can scoop and measure out up to nine grams of formula into this primary compartment which permits the user to simply twist it, releasing the powder into the bottle. To further enhance functionality, the Baby Bottle With Compartment is strategically designed with a Natum bottle nipple that is easily accepted by babies as a medium for feeding. This innovative, top-quality product eliminates the hassle of measuring out formula when it isn't convenient and/or when in a rush, making the accessory a potential benefit to all parent/caregivers.

Although the operations of the methods) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A baby bottle device comprising:
a baby bottle having an end, a cylindrical side having at least one squeeze portion and a threaded top;
a nipple ring having a nipple and a threaded ring configured to engage with the baby bottle threaded top and having a concentric lip adjacent the threaded ring; and
a dry storage having an open end received adjacent the concentric lip and a membrane for separation with a volume of the baby bottle,
wherein the membrane is configured to rupture from a pressure on the at least one squeeze portion of the baby bottle and allow a mixing of the dry storage with a liquid in the volume thereof.

2. The baby bottle device of claim 1, further comprising a bottle vent component configured concentric with the baby bottle and received into the threaded top.

3. The baby bottle device of claim 1, wherein the nipple of the nipple ring is a vent for the pressure to escape through the membrane in a breakage thereof.

4. The baby bottle device of claim 1, further comprising a bottle vent component having a different diameter larger than a diameter of the baby bottle and a plurality of vents in the difference thereof to vent the pressure through a break of the membrane.

5. The baby bottle device of claim 1, wherein the baby bottle and the nipple ring is an ergonomic design.

6. The baby bottle device of claim 1, wherein the dry storage is configured concentric with the baby bottle.

7. The baby bottle device of claim 1, wherein the baby bottle end is open and the at least one squeeze portion is a liquid bag suspended therein.

8. The baby bottle device of claim 1, wherein the at least one squeeze portion is a thumb and a finger depression on a soft portion of the cylindrical side of the baby bottle.

9. The baby bottle device of claim 1, wherein the at least one squeeze portion is a button portion on the cylindrical side of the baby bottle.

10. The baby bottle device of claim 1, wherein the membrane has scored lines and scored sections configured to create break lines in the membrane in reaction to the pressure.

11. The baby bottle device of claim 1, Wherein the dry storage further comprises a soft cylindrical side configured to grip an inside of the baby bottle.

12. The baby bottle device of claim 10, wherein a twist action on the nipple ring torques the soft cylindrical side and breaks the membrane.

13. The baby bottle device of claim 1, wherein the dry storage attaches to the concentric lip via a frictional mechanical relationship.

14. The baby bottle device of claim 1, further comprising a second membrane opposite the separation membrane for isolation of the dry storage from the nipple.

15. The baby bottle device of claim 1, wherein a shape of the dry storage is a cylindrical puck having a diameter less than a diameter of the baby bottle and membranes on both circular ends thereof.

16. The baby bottle device of claim 1, wherein a shear stress of the membrane is less than the pressure on the at least one squeeze portion of the baby bottle.
